(19) United States
(12) Patent Application Publication
(10) Pub. No.: US 2015/0176621 A1
(43) Pub. Date: Jun. 25, 2015

(54) FASTENER FOR VEHICLE

(71) Applicant: Hyundai Motor Company, Seoul (KR)

(72) Inventor: Dong Youl LEE, Hwaseong-Si (KR)

(73) Assignee: Hyundai Motor Company, Seoul (KR)

(21) Appl. No.: 14/541,084

(22) Filed: Nov. 13, 2014

(30) Foreign Application Priority Data
Dec. 24, 2013 (KR) 10-2013-0162016

(51) Int. Cl. F16B 19/10

(52) U.S. Cl. CPC F16B 19/1027

(57) ABSTRACT

A fastener for a vehicle may include an outer piece and an inner piece. The outer piece may include two split pin portions that are spaced apart and are elastically deflectable and retractile, and a plurality of catching portions that is arranged on an outer surface of each of the split pin portions in a longitudinal direction of the outer piece to perform an engagement action in fastening holes of a component and a panel. The inner piece may include a pin portion that is to be longitudinally inserted into a space formed by the spaced two split pin portions. The pin portion of the inner piece may deflect the two split pin portions outward in a state in which the pin portion is inserted into the space formed by the spaced two split pin portions of the outer piece so that the catching portions are engaged in the fastening holes, thus fastening the component and the panel.

### CROSS-REFERENCE TO RELATED APPLICATION

The present application claims priority of Korean Patent Application Number 10-2013-0162016 filed on Dec. 24, 2013, the entire contents of which application are incorporated herein for all purposes by this reference.

### BACKGROUND OF INVENTION

1. Field of Invention

The present invention relates to a fastener for a vehicle. More particularly, the present disclosure relates to a fastener for a vehicle which provides a sufficient fixing force (fastening force), is easy to be detached and disassembled, prevents damage during a detaching process to increase a reuse factor, and may prevent damage to a component (e.g., a thermal insulator or the like) to prevent dust from being dispersed.

2. Description of Related Art

Recently, plastic fasteners are widely used to connect panels and components such as interior and exterior components of a vehicle, for example, bumpers, wheel guards, tail gate trims, and cowl top covers. In addition, the plastic fasteners are widely used to fix and attach a thermal insulator such as non-woven fabrics, glass wool, or PU foam to a hood panel.

The fastener should be manufactured to have a shape that can prevent the component attached to the panel from being lifted up and causing clearance after assembling the fastener, and to have a structure which exhibits a sufficient holding force that can stably fix the component to the panel, and securely maintain the fixed state of the component.

In addition, the fastener should have an excellent assembly property and mountability when the component is fixed, and be configured to be easily detached when the fastener is detached, such that holes or the like at an assembly portion should not be damaged, and dust should not be generated due to damage to the component.

FIG. 1 is a view illustrating a fastener in the related art which is used to fix a thermal insulator to a hood panel, and illustrates a state in which a panel 1 and a thermal insulator 2 are fixed.

The illustrated fastener 3 has an arrowhead shape, and includes a head portion 4 which compresses the thermal insulator 2, a pin portion 5 which is formed integrally with the head portion 4, and penetratively inserted into a fastening hole of the panel 1, and a hook-shaped clip portion 6 which is formed integrally with the pin portion 5 so as to perform an engagement action in the fastening hole of the panel 1.

However, the fastener 3 has the hook-shaped clip portion 6 that provides an excellent fastening force, but provides excessive fastening force that is greater than a required level, and thus, a large amount of a force (excessive detaching force) is needed to detach the fastener, and as a result, there is a drawback that the fastener cannot be easily disassembled.

That is, in order to detach the fastener, the head portion 4 and the thermal insulator 1 can be separated by forcedly inserting a screw driver or a special tool dedicated for disassembly into a gap between the head portion 4 and the thermal insulator 1 (this process requires a special tool). In this regard, there are problems that it is difficult to forcedly separate and detach the fastener 3 due to an excessive fastening force by the fastener 3, and the head portion 4 of the fastener 3 may be damaged during the detachment process.

Particularly, in addition to the head portion 4, other portions such as the pin portion 5 and the clip portion 6 that perform an engagement action may be damaged and deformed, and thus, after the fastener is detached for any purpose (A/S or the like), the fastener cannot be reused (which causes an increase in A/S cost). Moreover, the thermal insulator 2 and the panel 1 may be damaged and deformed, and dust may be generated due to damage to the thermal insulator, such as surface scratches of the thermal insulator, or damage to hole portions, which causes difficulty at the time of work because the dust is dispersed.

Korean Patent Application Publication Nos. 10-2013-0084348 (Jul. 25, 2013), 10-2013-0084349 (Jul. 25, 2013), and 10-2011-0101004 (Sep. 15, 2011) disclose a fastener having a double-piece configuration in which an inner piece and an outer piece are assembled inward and outward so as to perform a locking operation, but this fastener is not suitable for fixing a component such as a thermal insulator of a hood in which a load and deflection are applied in a vertical direction.

That is, in the case of the component such as the thermal insulator of the hood panel, a weight of which is applied in a vertical direction, the fastener needs to securely support the component in the vertical direction after inserting the fastener. However, because the fastener having the double-piece configuration causes the component to be sagged and lifted up, the fastener is not suitable for use in attaching the thermal insulator.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art and/or other problems, and provides a fastener for a vehicle which may provide sufficient fixing force (fastening force), may be easy to be detached and disassembled, may prevent damage during a detaching process so as to increase a reuse factor, and may prevent damage to a component (a thermal insulator or the like) so as to prevent dust from being dispersed.

In various aspects, the present invention provides a fastener for a vehicle, including: an outer piece which includes two split pin portions that are spaced apart and are elastically deflectable and retractile, and a plurality of catching portions that is arranged on an outer surface of each of the split pin portions in a longitudinal direction of the outer piece to perform an engagement action in fastening holes of a component and a panel; and an inner piece which includes a pin portion that is to be longitudinally inserted into a space formed by the spaced two split pin portions, wherein the pin portion of the inner piece deflects the two split pin portions outward in a state in which the pin portion is inserted into the space formed by the spaced two split pin portions of the outer piece so that the catching portions are engaged in the fastening holes, thereby fastening the component and the panel.

In an aspect, the split pin portions of the outer piece may be formed integrally with a head portion of the outer piece that is formed substantially in a circular plate shape, the pin portion of the inner piece may be formed integrally with a head portion of the inner piece that is formed substantially in a circular plate shape, and the pin portion of the inner piece may be inserted into the space formed by the spaced two split pin portions through a through hole that is formed in the head portion of the outer piece.

In another aspect, an insertion groove into which the head portion of the inner piece is seated and inserted may be formed around the through hole of the head portion of the outer piece.

In still another aspect, a surface of the head portion of the outer piece and a surface of the head portion of the inner piece may form one continuously curved surface when the head portion of the inner piece is inserted into and seated on the insertion groove formed in the head portion of the outer piece.

In yet another aspect, fitting grooves, which are used to separate the head portion of the inner piece from the head portion of the outer piece by fitting a tool or an end of a finger into the fitting grooves, may be formed at one side and the other side around the insertion groove.

In still yet another aspect, a catching projection may protrude on the pin portion of the inner piece and engage with an inner portion of the through hole to prevent the inner piece from being completely separated from the outer piece once the inner piece is inserted through the through hole; and a recessed groove may be formed in the through hole of the head portion of the outer piece so that the catching projection is fitted into and passes through the recessed groove

In a further aspect, the outer piece may have a structure in which the two split pin portions are longitudinally extended from the head portion, the catching portions may protrude on each of the split pin portions to have a structure that is inclined toward the head portion of the outer piece, and the catching portions may be arranged on each of the split pin portions in the longitudinal direction of the outer piece and may be formed in two columns on each of the split pin portions.

In another further aspect, the catching portions in two columns may be formed on each of the split pin portions so as to have a difference in height, which is measured from the head portion, between laterally neighboring catching portions among the catching portions in two columns, such that the laterally neighboring two catching portions are arranged in a staggered arrangement in terms of height.

In still another further aspect, among the catching portions in four columns formed in the two split pin portions, the catching portions in two columns which are disposed in a diagonal direction based on the two split pin portions may be formed to have a same height, such that the catching portions positioned in the diagonal direction may perform an engagement action in the fastening hole of the panel.

In yet another further aspect, pressing projections may protrude on both side surfaces of the pin portion of the inner piece, and protruding portions may formed on inner surfaces of the split pin portions of the outer piece and may be pressed by the pressing projections of the inner piece to deflect the split pin portions outward.

According to the fastener for a vehicle of the present invention, when the fastener is fastened, the fastener may be simply fastened by just pushing the fastener after inserting the fastener, which is temporarily assembled to the component, into the fastening hole of the panel, and when the fastener is disassembled, the fastener may be easily disassembled by pulling out the head portion of the inner piece so as to be separated from the head portion of the outer piece such that the pressing projections are pulled out from between the protruding portions.

Particularly, when the fastener of various embodiments is temporarily assembled to the component, the fastener is temporarily assembled to the component in the same shape as that when the fastener is fully fastened, such that the component may be supplied to an in-line assembly process without separating the fastener, and then fastened to the panel.

In addition, since the fastener provides rigid fastening force, and requires an appropriate insertion force and separation force, the fastener may be easily fastened and disassembled. Moreover, since the fastener may securely fasten and lock the component and the panel, the fastener is very useful when the thermal insulator such as glass wool, non-woven fabric, and PU foam is fixed to a vehicle body panel such as a hood panel.

In addition, since the fastener of various embodiments has the catching portions having the stepped pine tree structure, the fastener may be widely used for the specifications of the panels and the components having various thicknesses.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a fastener in the related art which is used to fix a thermal insulator to a hood panel;

FIG. 2A and FIG. 2B illustrate an exemplary fastener according to the present invention, in which FIG. 2A is an assembled top perspective view and FIG. 2B is an assembled bottom perspective view;

FIG. 3A, FIG. 3B, FIG. 3C and FIG. 3D illustrate an exemplary fastener according to the present invention;

FIG. 4A and FIG. 4B illustrate an outer piece of an exemplary fastener according to the present invention, in which FIG. 4A is a top perspective view and FIG. 4B is a bottom perspective view;

FIG. 5A, FIG. 5B and FIG. 5C illustrate an outer piece of an exemplary fastener according to the present invention, in which FIGS. 5A, 5B, and 5C are a front view, a side view, and a bottom view, respectively;

FIG. 6 is a top perspective view illustrating an inner piece of an exemplary fastener according to the present invention;

FIG. 7A, FIG. 7B and FIG. 7C illustrate an inner piece of an exemplary fastener according to the present invention, in which FIGS. 7A, 7B and 7C are a front view, a side view, and a top plan view, respectively;

FIG. 8A and FIG. 8B are perspective views illustrating a fastened state of an exemplary fastener according to the present invention;

FIG. 9 is a cross-sectional view taken along line A-A of FIG. 8A;

FIG. 10 is a cross-sectional view illustrating a state when an exemplary fastener according to the present invention is disassembled;

FIG. 11 is a cross-sectional view taken along line B-B of FIG. 8A;

FIG. 12 is a cross-sectional view illustrating a state in which an exemplary fastener according to the present invention is temporarily assembled to a fastening hole of a component; and

FIG. 13 is a cross-sectional view illustrating a state in which an exemplary fastener according to the present invention is inserted into a fastening hole of a panel in a state in which the fastener is temporarily assembled to the fastening hole of the component.

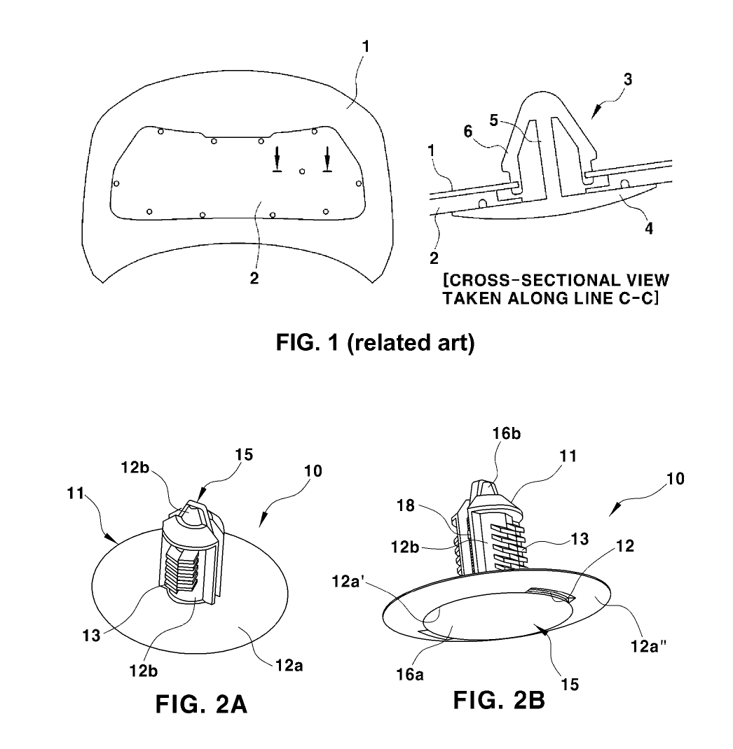

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention provides a fastener for a vehicle which may provide sufficient fixing force (fastening force), may be easily detached and disassembled, may prevent damage during a detaching process so as to increase a reuse factor, and may prevent damage to a component (a thermal insulator or the like) so as to prevent dust from being dispersed.

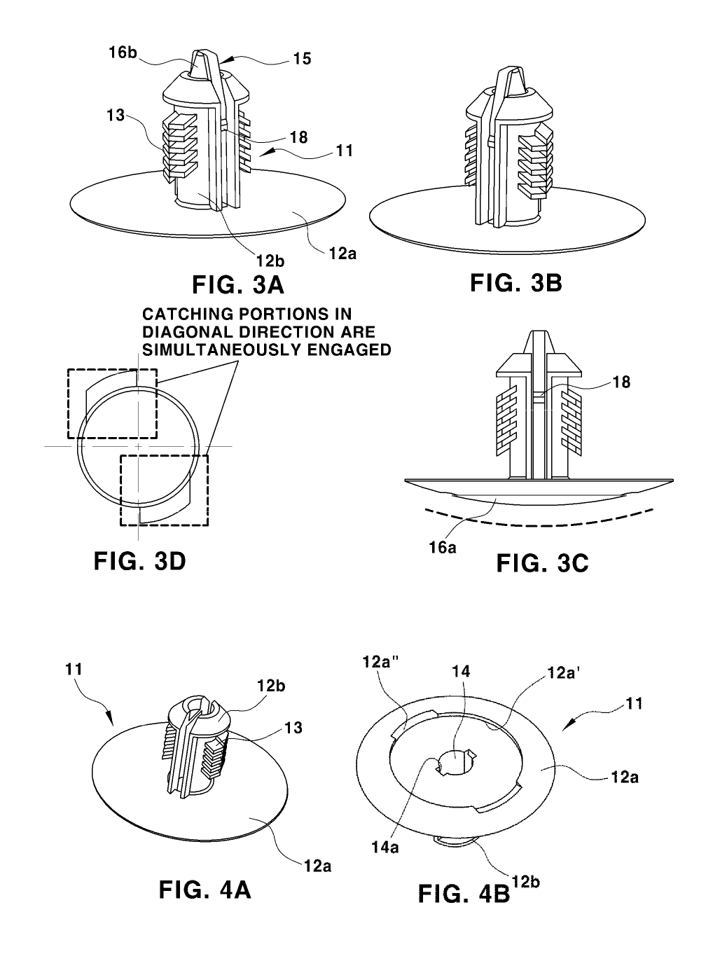

FIG. 2 is an assembled perspective view illustrating a fastener according to various embodiments, in which FIG. 2A is a top perspective view in an assembled state, and FIG. 2B is a bottom perspective view in the assembled state, and FIG. 3, including FIGS. 3A-3D, is an assembled perspective view illustrating the fastener according to various embodiments, which is a top perspective view viewed at an angle that is different from that of FIG. 2.

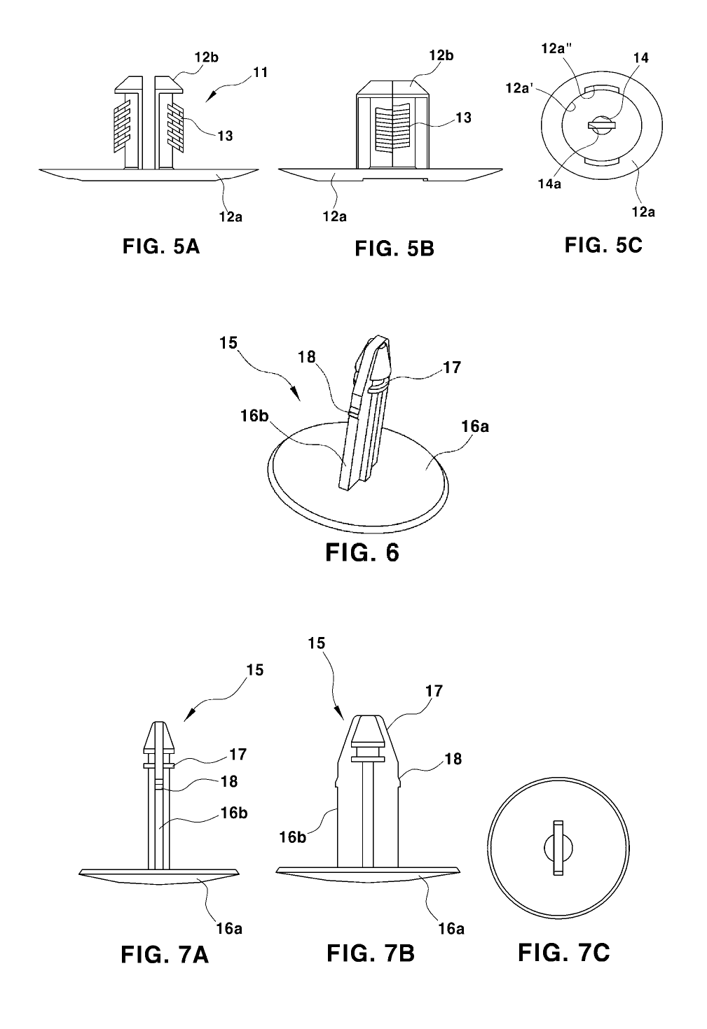

FIG. 4 is a top perspective view (FIG. 4A) and a bottom perspective view (FIG. 4B) illustrating an outer piece of the fastener according to various embodiments, and FIG. 5 is a front view (FIG. 5A), a side view (FIG. 5B), and a bottom view (FIG. 5C) of the outer piece of the fastener according to various embodiments.

In addition, FIG. 6 is a top perspective view illustrating an inner piece of the fastener according to various embodiments, and FIG. 7 is a front view (FIG. 7A), a side view (FIG. 7B), a top plan view (FIG. 7C) illustrating the inner piece of the fastener according to various embodiments.

First, as illustrated in FIGS. 2 and 3, a fastener 10 of various embodiments serves to fix a board-like component such as a thermal insulator to a vehicle body panel such as a hood panel, and has a double-piece (two-piece) configuration in which an outer piece 11 and an inner piece 15 are combined or coupled.

That is, the fastener 10 of various embodiments includes: an outer piece 11 which has split pin portions such as two split pin portions 12b that may be spread or deflected and refracted, and a plurality of catching portions 13 that is disposed on an outer surface of each of the split pin portions, and spaced apart from each other in a longitudinal direction so as to perform an engagement action in a fastening hole of a component (e.g., a thermal insulator) and a fastening hole of a panel (hood panel); and an inner piece 15 which is inserted into the outer piece 11 so as to maintain a spread shape of the outer piece so that the catching portion 13 of the outer piece may perform an engagement action in the fastening holes of the component and the panel.

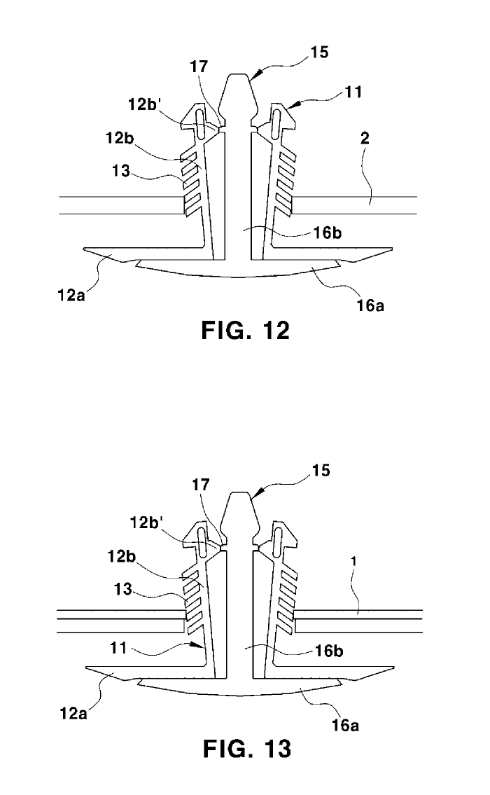

The fastener 10, which has the aforementioned configuration or the like, is provided in a state in which the fastener is inserted into the fastening hole of the component (thermal insulator) (reference numeral is 2 in FIG. 12) in a state in which the inner piece 15 is assembled inside the outer piece 11 (the fastener is provided in a state in which the fastener is temporarily assembled to the component), and in this case, the inner piece 15 is fully inserted into the outer piece 11, and the outer piece 11 is spread by the inner piece 15, that is, the two split pin portions 12b are spread or deflected outward, such that the fastener 10 is not pulled out from the fastening hole of the component 2 (see FIG. 12).

That is, the catching portions 13 of the split pin portions 12b, which are spread or deflected when the inner piece 15 is into the outer piece 11, are first engaged in the fastening hole of the component 2 such that the outer piece 11 is not pulled out, and as a result, the whole fastener 10 in which the inner piece 15 and the outer piece 11 are assembled is maintained in a state in which the fastener 10 is assembled so as not to be pulled out from the component in a state in which the fastener 10 is engaged in the fastening hole of the component 2 (see FIG. 12).

In this state, when the outer piece 11 is inserted into the fastening hole of the panel 1 (see FIG. 13), the catching portions 13 of the outer piece 11 are engaged in the fastening hole of the panel 1 so as not to be pulled out from the fastening hole (a fully fastened state of the fastener), such that the component 2 may be fixed to the panel 1 by fastening the fastener 10 as described above.

The outer piece 15 includes a head portion 12a having a circular plate shape or a substantially circular plate shape, and the two elongated split pin portions 12b that are formed integrally with the head portion 12a and may be elastically spread and retracted, and a pin portion 16b of the inner piece 15 is longitudinally inserted into a space inside the outer piece 11 which is provided by the two split pin portions 12b that are spaced apart from each other.

When the inner piece 15 is fully inserted into the outer piece 11, the split pin portions 12b of the outer piece 11 are spread by the inner piece 15, and in this case, the catching portions 13 of the outer piece 11 are engaged in the fastening hole of the component 2, and as a result, the whole fastener 10 is not pulled out from the fastening hole of the component 1.

In order to assemble the inner piece, as illustrated in FIG. 4B, a through hole 14, which is provided so that the pin portion 16b of the inner piece 15 may pass through the through hole 14 so as to be inserted into the split pin portions 12b of the outer piece 11 (i.e., into the space formed by the spaced split pin portions 12b), is formed at a central position of the head portion 12a of the outer piece 11.

In addition, an insertion groove such as a circular insertion groove 12a′ into which a head portion 16a of the inner piece 15 may be inserted is formed around the through hole 14 of the head portion 12a of the outer piece 11.

Therefore, when the pin portion 16b of the inner piece 15 is fitted into the through hole 14, and thereafter fully inserted into the split pin portions 12b of the outer piece 11, the head portion 16a of the inner piece 15 is inserted into and seated on the insertion groove 12a′ that is formed in the head portion 12a of the outer piece 11.

In addition, when the inner piece 15 is fully inserted, surfaces (lower surfaces when viewed in the drawings) of the head portions 12a and 16a of both the pieces 11 and 15 form an external appearance having a curved surface, an example of which is illustrated in FIG. 2(c), in a state in which both the pieces 11 and 15 are combined, that is, in a state in which the head portion 16a of the inner piece 15 is seated on and inserted into the insertion groove 12a′ of the head portion of the outer piece 11.

As such, the head portion of the outer piece and the head portion of the inner piece are combined so as to form one continuously curved surface having no protruding portion, thereby improving an aesthetic appearance.

In addition, fitting grooves 12a″, which are used to disassemble the fastener, are formed at one side and the other side around the insertion groove 12a′ of the head portion 12a of the outer piece 11, and when a tool such as a screw driver or an end of a finger is inserted into the fitting groove 12a″ in a state in which the outer piece 11 and the inner piece 15 are assembled, and then the head portion 16a of the inner piece 15 is pulled so as to be separated from the head portion 12a of the outer piece 11, the inner piece 15 may be pulled out and separated from the outer piece 11.

In addition, as described above, the outer piece 11 has the spaced two split pin portions 12b, and particularly, the plurality of catching portions 13, which protrudes to be engaged in the fastening holes of the component 2 and the panel 1, is formed on each of the split pin portions 12b while being arranged in a longitudinal direction at predetermined intervals (see FIG. 5A).

In this case, the catching portions 13, which are formed on each of the split pin portions 12b so as to have a structure in which the catching portions are spaced apart from each other in the longitudinal direction, have a structure in which the catching portions 13 protrude in both directions based on the split pin portions 12b of the outer piece 11, and particularly, each of the catching portions 13 protrudes to be inclined toward the head portion 12a, such that the entire shape of the split pin portions 12b and the catching portions 13 has a pine tree shape, as illustrated in FIG. 5A.

In addition, the catching portions 13 are formed on each of the split pin portions 12b so as to be in columns such as in two columns in the longitudinal direction, and as illustrated in FIG. 5B, the catching portions in two columns are formed on each of the split pin portions so as to have a difference in height, which is measured from the head portion 12a, between laterally neighboring two catching portions.

That is, referring to FIG. 5B, there is a difference in height between each of the catching portions 13 in the left arrangement and each of the catching portions in the right arrangement, such that the laterally neighboring two catching portions are arranged in a staggered arrangement in terms of height, and as a result, the left catching portions and the right catching portions overall have a stepped structure.

As such, the fastener of various embodiments is characterized in that the catching portions having a stepped pine tree structure are formed on the outer piece, and with this characteristic catching portion structure, the fastener may be widely used for the specifications of the panel and the component having various thicknesses without being affected by the thicknesses of the panel and the component, and as a result, there is an advantage in that the fastener has excellent versatility.

That is, the catching portions having the stepped pine tree structure allow the fastener to be widely used for various specifications of the panel and the component having a difference in thickness, and with this catching portion structure, locking force, which is precise and rigid regardless of the thickness, may be implemented for all the panels and the components having various specifications.

In addition, the catching portions 13 are formed in two columns on each of the split pin portions 12b such that the catching portions 13 protrude in a total of four columns of the outer piece 11, and the catching portions in two arrangements, which are disposed in a diagonal direction based on the two split pin portions, have the same height.

As illustrated in FIG. 3D, with this structure, the catching portions 13, which are positioned in the diagonal direction, perform an engagement action in the fastening hole of the panel, depending on the thickness of the panel. While FIG. 3D illustrates that the catching portions, which are positioned on a diagonal line at the left upper end and the right lower end in the drawing, perform the engagement action, the catching portions, which are positioned on a diagonal line at the right upper end and the left lower end may perform the engagement action depending on the thickness of the panel.

Meanwhile, the inner piece 15 includes the head portion 16a having a circular plate shape, and the elongated pin portion 16b that is fixedly formed integrally with the head portion 16a. In this case, the pin portion 16b has a sharp end having a plate shape, but has a structure in which pressing projections 17 are formed at both side surfaces so as to spread the split pin portions 12b of the outer piece 11.

In addition, the pin portion 16b of the inner piece 15 is longitudinally inserted into the space in the outer piece 11, that is, the space formed by the spaced split pin portions 12b, through the through hole 14 illustrated in FIG. 4B. In this case, the pin portion 16b is inserted so that catching projections 18, which protrude at both sides of the pin portion 16b of the inner piece 15, are fitted into recessed grooves 14a that are formed at both sides of the through hole 14 of the outer piece 11.

The catching projections 18 serve to prevent the inner piece from being fully pulled out and separated from the outer piece by preventing the inner piece 15 from being fully pulled out from the outer piece 11 even though a part of the pin portion 16b of the inner piece 15 is pulled out from the outer piece 11 after the fastener is disassembled.

That is, the catching projections 18 are used to prevent the two pieces 11 and 15 from being completely separated from each other (the catching projections serve as a catching portion for preventing the inner piece from being separated). When the inner piece 15 is maintained in a rotated state even though a part of the pin portion 16b of the inner piece 15 is pulled out from the outer piece 11 after the fastener is disassembled, the catching projections 18 are engaged with an inner portion of the through hole 14 in a state in which the catching projections 18 do not match the recessed grooves 14a of the outer piece 11, thereby preventing the inner piece from being fully pulled out.

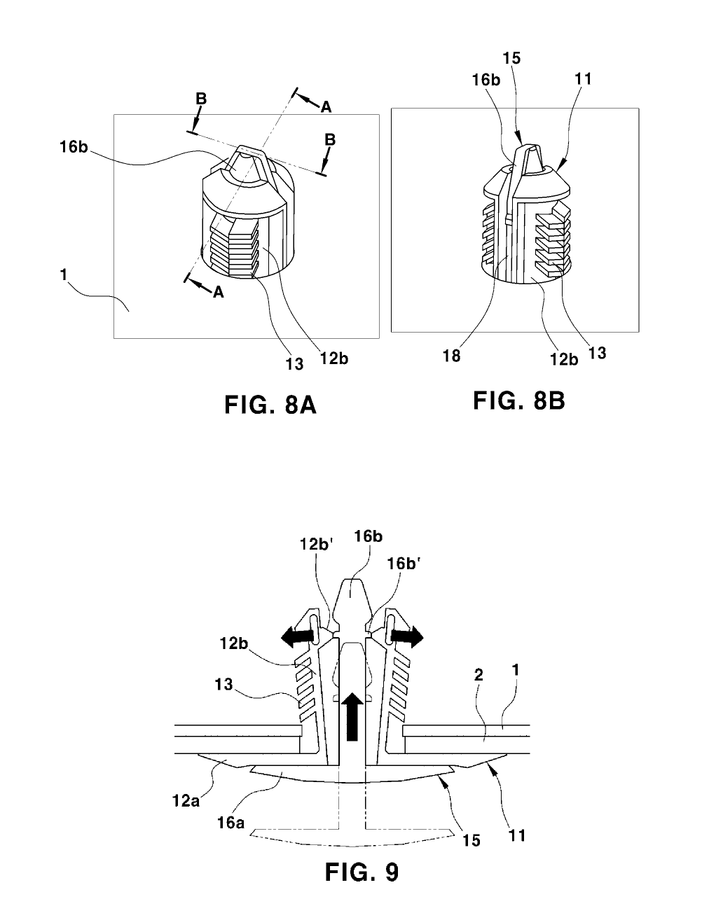

Next, FIGS. 8A and 8B are perspective views illustrating a fastened state of the fastener according to various embodiments, and illustrates a fastened state in which the split pin portions 12b of the outer piece 11 and the pin portion 16b of the inner piece 15 inside the outer piece 11 are inserted into the fastening hole of the panel 1 in a state in which the outer piece 11 and the inner piece 15 are assembled in advance, and thereafter, the catching portions 13 of the outer piece 11 are engaged in the fastening hole of the panel.

FIG. 9 is a cross-sectional view taken along line A-A of FIG. 8A, illustrates a cross-sectional structure of a fastened state in which the component 2 is fixed to the panel 1 using the fastener 10 according to various embodiments, and shows that the fastened state is maintained in a state in which the inner piece 15 is inserted into the outer piece 11.

As illustrated in FIG. 9, the pressing projections 17 protrude on both side surfaces of the pin portion 16b of the inner piece 15, and protruding portions 12b′, which are pressed by the pressing projections of the inner piece so as to cause the split pin portions to be spread or deflected outward, are formed on inner surfaces of tip portions of the split pin portions 12b of the outer piece 11.

Therefore, the pressing projections 17 of the inner piece 15 push the protruding portions 12b′ of the outer piece 11 outward toward both sides when viewed in the drawing in a state in which the inner piece 15 is fully inserted into the outer piece 11, and thereby, the split pin portions 12b of the outer piece 11 are spread or deflected outward.

In a state in which the split pin portions 15b are spread or deflected outward and enlarged as described above, the catching portions 13 of both the split pin portions are engaged in the fastening hole of the panel 1, which becomes the fastened state in which the component 2 is fixed to the panel 1.

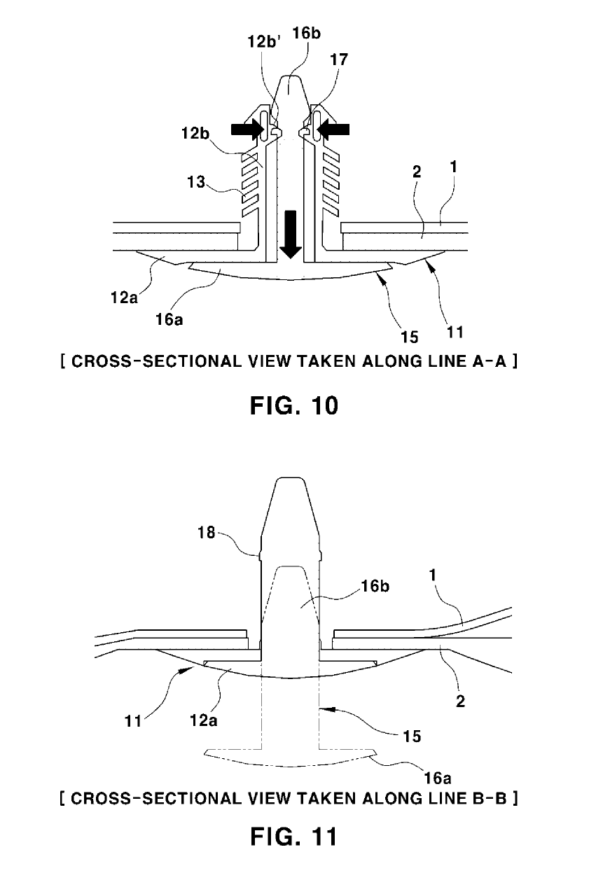

FIG. 10 is a cross-sectional view when the fastener is disassembled, that is, a cross-sectional view illustrating a state in which the fastened state of the fastener is released in order to separate the component from the panel, and illustrates a state in which the inner piece 15 is pulled out downward from the outer piece 11 in order to disassemble the fastener.

As illustrated in FIG. 10, when the inner piece 15 is pulled out downward, the pressing projections 17 of the inner piece 15 are pulled out from between the protruding portions 12b′ of the outer piece 11 (the pressing projections are separated from the protruding portion) while the pin portion 16b of the inner piece 15 is moved downward, and in this case, the split pin portions 12b of the outer piece 11 are retracted inward toward a center thereof while being elastically restored.

In a state in which the split pin portions 12b of the outer piece 11 are retracted while being elastically restored, as described above, ends of the catching portions 13 of the outer piece are positioned inside the fastening hole so as to have intervals with the fastening hole of the panel 1, such that the outer piece may be easily pulled out from the fastening hole of the panel.

FIG. 11 is a cross-sectional view taken along line B-B of FIG. 8A, the catching projections 18 of the inner piece are engaged with the inner portion of the through hole 14 of the outer piece 11 even though the inner piece 15 is moved as described above, and then pulled out downward when viewed in the drawing. As a result, the inner piece 15 is no longer pulled out downward, and the catching projections are engaged, such that the inner piece is prevented from being fully separated from the outer piece.

That is, since the inner piece is prevented by the catching projections from being fully pulled out and separated from the outer piece, a state in which the inner piece and the outer piece are coupled may be continuously maintained in a state in which the catching projections are engaged.

FIG. 12 is a cross-sectional view illustrating a state (temporarily assembled state) in which the fastener is coupled to the fastening hole of the component when the component (e.g., thermal insulator) is supplied. When the component 2 is supplied to be assembled with the panel 1, the component 2 is supplied in a state in which the fastener 10 is coupled to the fastening hole of the component 2.

In this case, the inner piece 15 and the outer piece 11, which are inserted into the fastening hole of the component 2, are coupled in the same manner as that in the fastened state. As illustrated in FIG. 12, the inner piece 15 is fully inserted into the outer piece 11, such that the split pin portions 12b of the outer piece are spread or deflected outward by the pressing projections 17 and the protruding portions 12b′.

Since the component is supplied in a state in which the fastener is coupled to the component in the fastened state as described above, there is no risk of causing the fastener to be separated before the component is fastened to the panel.

In addition, the fastener 10, which is temporarily assembled in the fastening hole of the component 2, is inserted into the fastening hole of the panel 1 as in a state illustrated in FIG. 12, and when the split pin portions 12b of the outer piece 11 are inserted into the fastening hole of the panel, the split pin portions 12b may be inserted into the fastening hole without damage to the panel 1 or the fastener (the outer piece) because the catching portions 13 of the split pin portions have the pine tree structure (a shape that is inclined toward the head portion, that is, a shape that is inclined downward when viewed in the drawing) that is inclined in a direction in which the catching portions 13 are inserted into the fastening hole.

FIG. 13 is a cross-sectional view illustrating a state in which the fastener is inserted into the fastening hole of the panel in a state in which the fastener is temporarily assembled in the fastening hole of the component. When the outer piece 11 is pushed through the head portion 12a after the outer piece 11 is inserted into the fastening hole of the panel 1, there is a state in which the catching portions 13 of the outer piece is engaged and fastened in the fastening hole of the panel, that is, the fastened state as illustrated in FIG. 9.

In order to make the fastened state as illustrated in FIG. 9, the outer piece 11 in the state illustrated in FIG. 13 is pushed until the head portion 12a of the outer piece 11 comes into contact with the component 2, and the fastener 10 in a fully fastened state is fixed in a state in which the catching portions 13 are engaged in the fastening hole of the panel 1 as illustrated in FIG. 9, and as a result, the fastener 10 integrally fastens and fixes the panel 1 and the component 2.

As described above, in a case of using the fastener of various embodiments, when the fastener is fastened, the fastener may be simply fastened by just pushing the fastener after inserting the fastener, which is temporarily assembled to the component, into the fastening hole of the panel, and when the fastener is disassembled, the fastener may be easily disassembled by pulling out the head portion of the inner piece so as to be separated from the head portion of the outer piece such that the pressing projections are pulled out from between the protruding portions.

Particularly, when the fastener of various embodiments is temporarily assembled to the component, the fastener is temporarily assembled to the component in the same shape as that when the fastener is fully fastened, such that the component may be supplied to an in-line assembly process without separating the fastener, and then fastened to the panel.

In addition, since the fastener provides rigid fastening force, and requires an appropriate insertion force and separation force, the fastener may be easily fastened and disassembled. Moreover, since the fastener may securely fasten and lock the component and the panel, the fastener is very useful when the thermal insulator such as glass wool, non-woven fabric, and PU foam is fixed to a vehicle body panel such as a hood panel.

In addition, since the fastener of various embodiments has the catching portions having the stepped pine tree structure, the fastener may be widely used for the specifications of the panels and the components having various thicknesses.

For convenience in explanation and accurate definition in the appended claims, the terms “inner” or “outer”, “left” or “right”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents. the split pin portions of the outer piece are formed integrally with a head portion of the outer piece that is formed substantially in a circular plate shape;

What is claimed is:

1. A fastener for a vehicle, comprising:
an outer piece which includes two split pin portions that are spaced apart and are elastically deflectable and retractile, and a plurality of catching portions that is arranged on an outer surface of each of the split pin portions in a longitudinal direction of the outer piece to perform an engagement action in fastening holes of a component and a panel; and
an inner piece which includes a pin portion that is to be longitudinally inserted into a space formed by the spaced two split pin portions,
wherein the pin portion of the inner piece deflects the two split pin portions outward in a state in which the pin portion is inserted into the space formed by the spaced two split pin portions of the outer piece so that the catching portions are engaged in the fastening holes, thereby fastening the component and the panel.

2. The fastener of claim 1, wherein:
the split pin portions of the outer piece are formed integrally with a head portion of the outer piece that is formed substantially in a circular plate shape;
the pin portion of the inner piece is formed integrally with a head portion of the inner piece that is formed substantially in a circular plate shape; and
the pin portion of the inner piece is inserted into the space formed by the spaced two split pin portions through a through hole that is formed in the head portion of the outer piece.

3. The fastener of claim 2, wherein an insertion groove into which the head portion of the inner piece is seated and inserted is formed around the through hole of the head portion of the outer piece.

4. The fastener of claim 3, wherein a surface of the head portion of the outer piece and a surface of the head portion of the inner piece form one continuously curved surface when the head portion of the inner piece is inserted into and seated on the insertion groove formed in the head portion of the outer piece.

5. The fastener of claim 4, wherein fitting grooves, which are used to separate the head portion of the inner piece from the head portion of the outer piece by fitting a tool or an end of a finger into the fitting grooves, are formed at one side and the other side around the insertion groove.

6. The fastener of claim 2, wherein:
a catching projection protrudes on the pin portion of the inner piece and engages with an inner portion of the through hole to prevent the inner piece from being completely separated from the outer piece once the inner piece is inserted through the through hole; and
a recessed groove is formed in the through hole of the head portion of the outer piece so that the catching projection is fitted into and passes through the recessed groove.

7. The fastener of claim 1, wherein the outer piece has a structure in which the two split pin portions are longitudinally extended from the head portion, the catching portions protrude on each of the split pin portions to have a structure that is inclined toward the head portion of the outer piece, and the catching portions are arranged on each of the split pin portions in the longitudinal direction of the outer piece and are formed in two columns on each of the split pin portions.

8. The fastener of claim 7, wherein the catching portions in two columns are formed on each of the split pin portions so as to have a difference in height, which is measured from the head portion, between laterally neighboring catching portions among the catching portions in two columns, such that the laterally neighboring two catching portions are arranged in a staggered arrangement in terms of height.

9. The fastener of claim 8, wherein among the catching portions in four columns formed in the two split pin portions, the catching portions in two columns which are disposed in a diagonal direction based on the two split pin portions are formed to have a same height, such that the catching portions positioned in the diagonal direction perform an engagement action in the fastening hole of the panel.

10. The fastener of claim 1, wherein pressing projections protrude on both side surfaces of the pin portion of the inner piece, and protruding portions are formed on inner surfaces of the split pin portions of the outer piece and are to be pressed by the pressing projections of the inner piece to deflect the split pin portions outward.
